(19) United States
(12) Patent Application Publication
(10) Pub. No.: US 2025/0288181 A1
(43) Pub. Date: Sep. 18, 2025

(54) DOOR LOCK DEVICE AND ELECTRICAL APPLIANCE

(71) Applicant: ILLINOIS TOOL WORKS INC., Glenview, IL (US)

(72) Inventors: Yang WANG, Dongguan City (CN); Zhenpeng SONG, Dongguan City (CN)

(73) Assignee: ILLINOIS TOOL WORKS INC., Glenview, IL (US)

(21) Appl. No.: 19/079,165

(22) Filed: Mar. 13, 2025

(30) Foreign Application Priority Data
Mar. 15, 2024 (CN) 202410299464.0
Mar. 10, 2025 (CN) 202510279290.6

(51) Int. Cl. A47L 15/42; E05B 47/00; E05B 65/00

(52) U.S. Cl. CPC A47L 15/4259; E05B 47/0002; E05B 65/00; E05B 2047/0016

(57) ABSTRACT

A door lock device, including a slider, a locking block, and a first biasing means. The slider includes a slider engagement portion and is configured to reciprocate between a first and a second position. The locking block includes a locking portion and is configured to be movable relative to the slider to removably engage the locking portion with the slider engagement portion. The first biasing means is configured to apply to the slider during movement of the slider from the first to the second position in a first direction in a state in which the locking portion is engaged with the slider engagement portion, a first biasing force which enables the slider to be actuated to move in the first direction. A user pushes the door to a position where it can be locked by the locking block, and after being locked, there is no need to continue to push.

### CROSS-REFERENCE TO RELATED APPLICATIONS

Chinese Patent Applications CN 202410299464.0, filed on 15 Mar. 2024 and CN 202510279290.6, filed on 10 Mar. 2025, the priority documents corresponding to this invention, to which a foreign priority benefit is claimed under Title 35, United States Code, Section 119, and their entire teachings are incorporated, by reference, into this specification.

### BACKGROUND OF THE INVENTION

### Field of the Invention

The present disclosure relates to a door lock device and an electrical appliance, and in particular to a door lock device capable of facilitating locking and unlocking of a door of an electric appliance, and an electrical appliance having the door lock device.

### Discussion of Related Art

Doors of electrical appliances such as dishwashers are usually equipped with door locks, and usually need to be locked after the doors are closed and to be unlocked before doors are opened.

In the prior art, the door lock devices for manual unlocking and the door lock devices for electromagnetic unlocking are two different sets of door lock devices. When a slider of a door lock device is moved to a door closed position, it is locked by a locking block, to lock a door. When unlocking is required, the door lock device for electromagnetic unlocking may send an unlocking signal to drive the locking block to unlock the door, and the door lock device for manual unlocking may be unlocked by manually pulling the door.

In the invention patent CN 103584814 B, a main body of an electrical appliance is provided with a pair of latch arms which can be held in a tightly clamped state under a pretensioning force of a spring, and a latch mounted on a door can overcome he pretensioning force of the spring and be pressed into a fastening region of the pair of latch arms, to keep a door of the electrical appliance locked.

### SUMMARY OF THE INVENTION

In the prior art, if it is necessary to replace the door lock device for manual unlocking with the door lock device for electromagnetic unlocking, the door lock device usually needs to be removed as a whole and remounted, so that the operation is complicated and cumbersome. In addition, during a locking of a door lock device illustrated in the invention patent CN 103584814 B, the user needs to push the door to the door closed position to lock the door, so that the locking process is relatively not smooth.

Therefore, according to a first aspect of the present disclosure, there is provided a door lock device, including a slider, a locking block, and a first biasing means. The slider includes a slider engagement portion, and the slider is configured to reciprocate in a first direction and a second direction opposite to the first direction between a first position and a second position. The locking block includes a locking portion, and the locking block is configured to be movable relative to the slider to removably engage the locking portion with the slider engagement portion. The first biasing means is configured to apply, to the slider during movement of the slider from the first position to the second position in the first direction in a state in which the locking portion is engaged with the slider engagement portion, a first direction biasing force which actuates the slider to move in the first direction.

According to the first aspect of the present disclosure, the first biasing means is configured to apply the first direction biasing force to the locking block such that the locking portion applies the first direction biasing force to the slider after the locking portion is engaged with the slider engagement portion.

According to the first aspect of the present disclosure, a travel of the slider moving in the first direction includes a third position between the first position and the second position, when the slider moves in the first direction to the third position, the locking portion is engageable with the slider engagement portion such that the first biasing means can apply the first direction biasing force to the slider.

According to the first aspect of the present disclosure, the first biasing means is configured to apply a third direction biasing force to the locking block, the third direction biasing force drives the locking block to move relative to the slider in the third direction to engage the locking portion with the slider engagement portion when the slider moves to the third position. According to the first aspect of the present disclosure, the first biasing means is an elastic component.

According to the first aspect of the present disclosure, the door lock device further includes: a second biasing means configured to apply, to the slider during movement of the slider from the second position to the first position in the second direction, a second direction biasing force which causes the slider to move in the second direction.

According to the first aspect of the present disclosure, the second biasing means includes one or more elastic components.

According to the first aspect of the present disclosure, the first biasing means is configured to enable the first direction biasing force applied by the first biasing means to cause the locking block to overcome the second direction biasing force of the second biasing means, to actuate the slider to move in the same direction during the movement of the locking block from the first position to the second position in the first direction.

According to the first aspect of the present disclosure, the slider engagement portion is a slider locking recess, the locking portion being capable of entering the slider locking recess during movement of the locking block to engage the locking block with the slider.

According to the first aspect of the present disclosure, the door lock device further includes: an unlocking structure configured to disengage the locking portion of the locking block from the slider engagement portion of the slider during movement of the locking block in a second direction.

According to the first aspect of the present disclosure, the unlocking structure includes: a guiding portion and a guide surface which is a side surface of the locking block facing the guiding portion, the guide surface being arranged obliquely with respect to the second direction, the guide surface being capable of interacting with the guiding portion during movement of the locking block toward the second movement direction, to enable the locking portion to be disengaged from the slider engagement portion.

According to the first aspect of the present disclosure, the door lock device further includes: a blocking portion configured such that the blocking portion abuts against the locking block to prevent the locking block from moving toward the second position before the slider moves to the third position in the first direction; and when the slider moves to the third position in the first direction, the locking portion aligns with the slider engagement portion along the third direction, to enable the locking block to disengage from the blocking portion under action of the third direction biasing force such that the locking portion engages with the slider engagement portion.

According to the first aspect of the present disclosure, after the slider moves in the second direction and the locking portion disengages from the slider engagement portion, the blocking portion abuts against the locking block to prevent the locking block from moving towards the second position.

According to the first aspect of the present disclosure, the door lock device further includes: an electromagnetic unlocking means detachably connected to the locking block and capable of driving the locking block such that the locking portion can be disengaged from the slider engagement portion.

According to the first aspect of the present disclosure, the door lock device further includes: a control means communicatively connected to the electromagnetic unlocking means to send a control signal to the electromagnetic unlocking means so as to drive the locking block to move.

According to the first aspect of the present disclosure, the door lock device further includes: a door lock box, wherein the slider, the locking block and the first biasing means are arranged in the door lock box, and the electromagnetic unlocking means is detachably connected to the door lock box.

According to the first aspect of the present disclosure, the door lock device further includes: a pair of locking arms arranged at an end of the slider away from the slider engagement portion, the pair of locking arms being configured to be switched between an open state and a closed state to receive or release a component for applying external pull force and external push force to the slider, wherein the slider is configured to move from the first position to the third position under action of the external push force and move from the second position to the first position under action of the external pull force.

According to a second aspect of the present disclosure, there is provided a door lock device including the door lock device according to the first aspect of the present disclosure, an electromagnetic unlocking means, and a control means. The electromagnetic unlocking means is detachably connected to the locking block and capable of driving the locking portion of the locking block such that the locking portion can be disengaged from the slider engagement portion. The control means is communicatively connected to the electromagnetic unlocking means to send a control signal to the electromagnetic unlocking means so as to drive the locking block to move.

According to a third aspect of the present disclosure, there is provided an electrical appliance including the door lock device according to the first or second aspect of the present disclosure, the door lock device being configured to open or close a door of the electrical appliance.

In the door lock device of the present disclosure, the first biasing means is configured to apply, to the slider during movement of the slider from the first position to the second position in the first direction in the state in which the locking portion is engaged with the slider engagement portion, the first direction biasing force which actuates the slider to move in the first direction, so that the user only needs to push the door (the slider) to a position where it can be locked by the locking block, and after being locked, there is no need to continue to apply pushing force. The locking block can drive the slider to automatically move towards the second position (e.g., a door closed position), thereby giving the user a feeling of the door being sucked in. This suction feeling can enhance the user's experience of using the electrical appliance.

Some of the additional aspects and advantages of the present disclosure will be set forth in the following description, and some will become apparent from the following description, or be learned by practice of the present disclosure.

### BRIEF DESCRIPTION OF SEVERAL VIEWS OF THE DRAWINGS

FIG. 1A is a front view of a first embodiment of a door lock device of the present disclosure with an upper cover hidden.

FIG. 1B is a front view of a second embodiment of a door lock device of the present disclosure with an upper cover hidden.

FIG. 2A is a partial view of FIG. 1A of the present disclosure.

FIG. 2B is a partial view of FIG. 1B of the present disclosure.

FIG. 3A is a schematic view of the first embodiment of the door lock device of the present disclosure in a door open position.

FIG. 3B is a schematic view of the first embodiment of the door lock device of the present disclosure in a force-assisted door closing stage.

FIG. 3C is a schematic view of the first embodiment of the door lock device of the present disclosure in a door closed position.

FIG. 3D is a schematic view of the first embodiment of the door lock device of the present disclosure in a door pulling stage.

FIG. 3E is a schematic view of the first embodiment of the door lock device of the present disclosure in a door pulling and unlocking stage.

FIG. 4A is a schematic view of the second embodiment of the door lock device of the present disclosure in a door closed position.

FIG. 4B is a schematic view of the second embodiment of the door lock device of the present disclosure in an unlocking critical position.

FIG. 4C is a schematic view of the second embodiment of the door lock device of the present disclosure in an unlocked position.

FIG. 5 is a schematic view of an electrical appliance having the door lock device of the present disclosure.

### DESCRIPTION OF PREFERRED EMBODIMENTS

Various specific embodiments of the present disclosure will be described below with reference to the accompanying drawings which constitute part of the present disclosure, but the embodiments would not limit the scope of the present disclosure. It should be understood that although the terms such as “upper”, “lower”, “left”, “right”, “front”, “rear” and so on indicating directions are used in the present disclosure to describe orientations of various illustrative structural parts and elements in the present disclosure, the terms used herein are merely used for ease of description and are determined based on the illustrative orientation shown in the accompanying drawings. Since the embodiments disclosed in the present disclosure can be arranged in different orientations, the terms indicating directions are merely illustrative and should not be considered as limitations.

The terms “first”, “second”, etc. used in the present disclosure are merely used to distinguish different objects, instead of indicating that there is any particular sequential relationship between these objects. The term “comprise/include” and derivatives thereof mean inclusion without limitation. Unless otherwise specified and limited, the terms “mounting”, “connecting” and “connection” should be understood in a broad sense. For example, they may be a mechanical or electrical connection, internal communication between two elements, or a direct connection or indirect connection via an intermediate medium. For those of ordinary skills in the art, the specific meanings of the above terms can be understood according to specific cases.

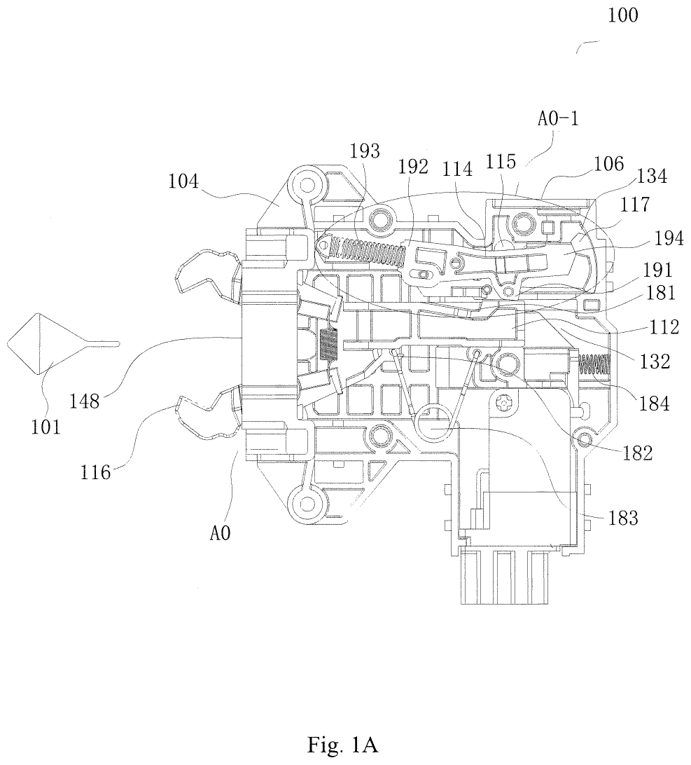

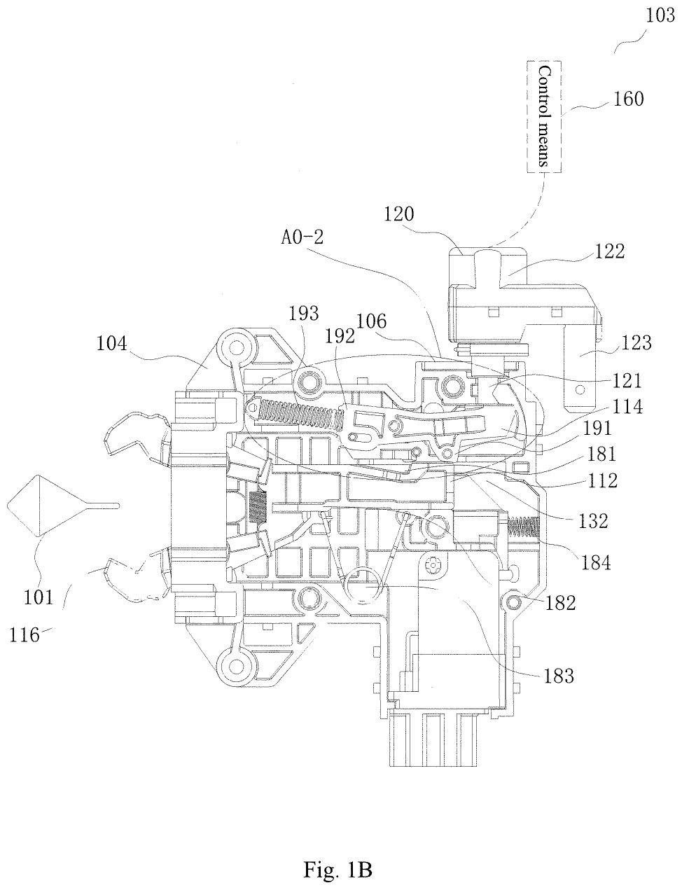

FIGS. 1A-1B are schematic views of two embodiments of a door lock device of the present disclosure. FIGS. 1A shows a first embodiment of the door lock device, and FIGS. 1B shows a second embodiment of the door lock device. In the first embodiment of the door lock device, the door lock device can be unlocked by applying a pulling force to the door (a slider). In the second embodiment of the door lock device, a locking block can be actuated by an electromagnetic unlocking means to unlock the door lock device.

The door lock device of the present disclosure has a modular design, including a travel switch module and an electromagnetic ejecting module. The user can choose whether to mount the electromagnetic ejecting module as needed, so that the opening of the door lock device can be switched between manual opening and automatic opening achieved by the automatic ejecting function. The travel switch module is a door lock device 100 with a door lock box structure shown in FIG. 1A, and the electromagnetic ejecting module is an electromagnetic unlocking means 120 shown in FIG. 1B.

As shown in FIG. 1A, the door lock device 100 includes a door lock box 104, the door lock box 104 being provided with an mounting hole for electromagnetic unlocking means 106 on one side for selectively mounting an electromagnetic ejecting module (an electromagnetic unlocking means). The door lock box 104 is internally provided with a slider 112, a locking block 114 arranged above the slider 112, and a pair of locking arms 116 swingingly arranged on the slider 112 to receive or release a component (striker 101) for applying external pull force and external push force to the slider 112. The door lock box 104 is internally provided with a slider recess 132 extending in a horizontal direction for receiving the slider 112 which can reciprocate in the horizontal direction inside the door lock box. In a travel of movement of the slider 112, it provides a first position, a second position and a third position between the first position and the second position. The first position is a door open position, the second position is a door closed position, and the third position is a locked position where the slider 112 locates when the slider 112 is engaged with the locking block 114, the slider 112 is configured to move from the first position to the third position under action of the external push force and move from the second position to the first position under action of the external pull force.

Continuing as shown in FIG. 1A, the slider 112 is provided with a slider engagement portion at the upper right position thereof. In an embodiment of the present disclosure, the slider engagement portion is a slider locking recess 181 configured to allow the locking block 114 to be inserted and thus locked by the locking block 114, thus the locking block 114 can drive the slider 112 to move together. For those skilled in the art, the slider engagement portion may be of a different structure without violating the above-mentioned inventive purpose. The pair of locking arms 116 are arranged at an end of the slider 112 away from the slider engagement portion (the left end in the figure), and the pair of locking arms 116 can be switched between an open state and a closed state during reciprocation of the slider 112 between the door open position and the door closed position, so as to release from or engage with a striker 101 mounted on the door. The door lock box 104 is further provided with an opening 148 on a left side, such that the locking arms 116 can extend from the inside of the door lock box 104 to the outside of the door lock box 104 through the opening 148.

Continuing as shown in FIG. 1A, the locking block 114 has a locking portion 191 provided on a lower side thereof for removable engagement with the slider locking recess 181 of the slider 112 to lock the slider 112. The door lock box 104 of the door lock device 100 is further internally provided with a first biasing means 193, and the locking block 114 is provided with a mounting portion for first biasing means 192 on a left side thereof for mounting the first biasing means 193, for example, an elastic component such as a compression spring. The first biasing means 193 is mounted at an inclined angle with respect to the sliding direction of the slider 112, such that a first direction biasing force for rightward movement direction of the locking block 114 and a third direction biasing force perpendicular to the rightward movement direction (for example, downward movement) are provided.

Continuing as shown in FIG. 1A, a second biasing means is further provided in the door lock box 104, and a mounting portion for second biasing means 182 is further provided on a lower side of the slider 112 for mounting the second biasing means such as one or more elastic components including slider torsion springs 183 or slider compression spring 184. Specifically, the second biasing means 183 is mounted between the mounting portion for second biasing means 182 of the slider 112 and the door lock box 104 for applying a biasing force to the slider 112 as the slider 112 moves leftward, to assist in its movement. For those skilled in the art, the second biasing means may be any form of elastic component or biasing means provided between the slider 112 and the door lock box 104, for example a slider tension spring provided between left side of the slider 112 and the door lock box 104 to provide a biasing force for the slider 112 to slide leftward.

In an embodiment of the present disclosure, the magnitude of the first direction biasing force provided by the first biasing means 193 to the locking block 114 is set to be greater than the magnitude of the second direction biasing force provided by the second biasing means to the slider 112, so that when the locking portion 191 of the locking block 114 and the slider locking recess 181 of the slider 112 are engaged with each other and are not subjected to any external force, the slider 112 and the locking block 114 are mutually locked and can move in the first direction (i.e., rightward in the figure). That is, the first biasing means 193 enables the locking block 114 to overcome the second direction biasing force of the second biasing means to actuate the slider 112 to move in the same direction. During the rightward movement of the slider 112 from the door open position to the door closed position, and in a state where the locking portion 191 is engaged with the slider engagement portion, the first biasing means 193 may apply, to the slider, a first direction biasing force which actuates the rightward movement of the slider 112.

In some other embodiments, for those of ordinary skill in the art, it is also possible to provide the first direction biasing force and the third direction biasing force, respectively, by providing two biasing means in the horizontal direction in FIG. 1A (a direction parallel to the sliding direction of the slider 112) and in the vertical direction in FIG. 1A (a direction perpendicular to the sliding direction of the slider 112). The two biasing means may be any form of elastic members, as long as they can provide biasing forces.

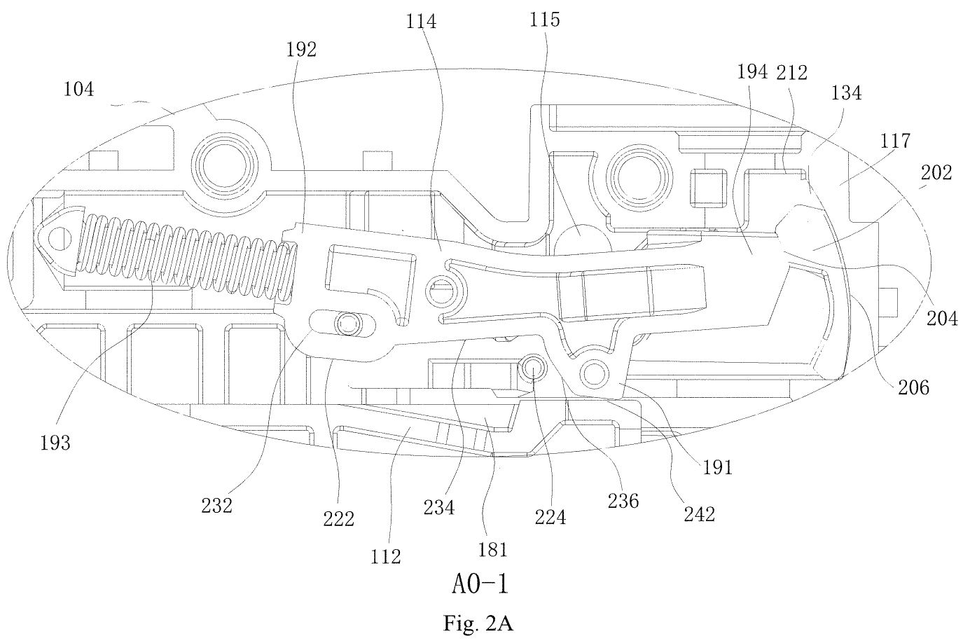

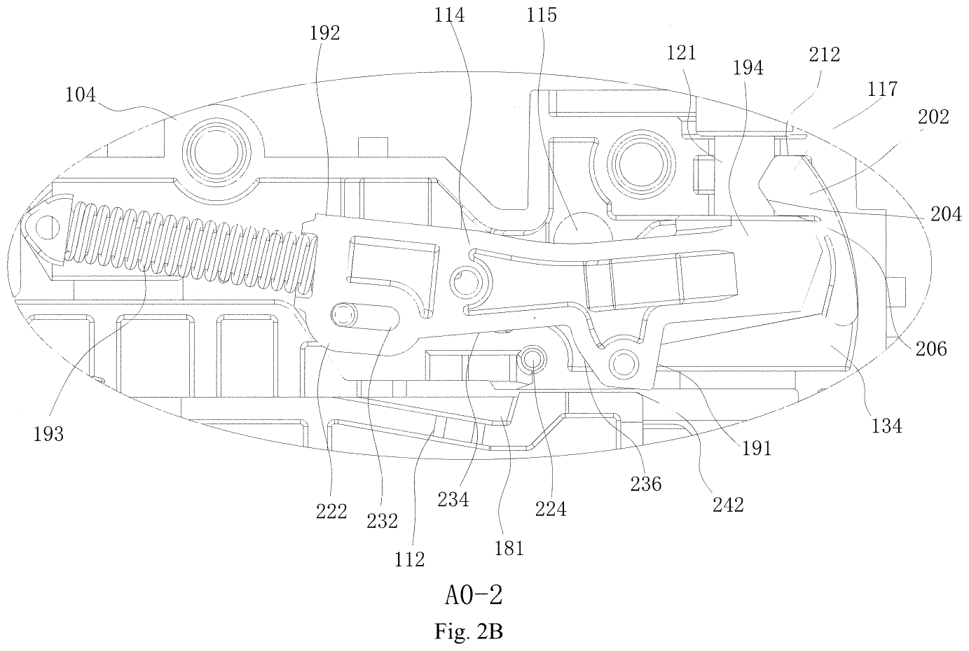

Continuing as shown in FIG. 1A, the door lock box 104 is further internally provided with a blocking portion. In an embodiment of the present disclosure, the blocking portion is an swinging block 117. The swinging block 117 is rotatably mounted inside the door lock box 104 via an swinging shaft 115. Accordingly, the door lock box 104 is internally provided with a swinging block slideway 134 that conforms with the profile of the right side of the swinging block 117 such that the swinging block 117 can swing back and forth about the swinging shaft 115 in the swinging block slideway 134. The locking block 114 is provided with an swinging block abutment portion 194 on the right side thereof for abutment against the swinging block 117. The specific structure of the swinging block 117 and the cooperative movement relationship between the locking block 114 and the swinging block 117 will be introduced in the description of FIGS. 2A-2B. In other embodiments, the blocking portion may be another type of structure instead of the swinging block.

As shown in FIG. 1B, in order to provide a selectable unlocking mode, the door lock device 103 according to the second embodiment of the present disclosure is further provided with an electromagnetic unlocking means 120. The electromagnetic unlocking means 120 extends through the mounting hole for electromagnetic unlocking means 106 into the interior of the door lock box 104 and is detachably connected to the locking block. In the embodiment in which the electromagnetic unlocking means 120 is mounted, the door lock device 100 is further provided with a control means 160, which can be communicatively connected to the electromagnetic unlocking means 120 in a wired or wireless manner, so that the electromagnetic unlocking means 120 can be operated to drive the locking block 114, and the locking portion 191 of the locking block 114 can be disengaged from the slider locking recess 181 to complete an unlocking operation of the door lock device. The user can choose the door lock device with an automatic unlocking function as needed, and the electromagnetic unlocking means 120 may be directly mounted to the door lock box 104 or removed from the door lock box 104, so that a quick and free switching between manual unlocking and automatic unlocking is achieved.

Continuing as shown in FIG. 1B, the electromagnetic unlocking means 120 is provided with a locking block actuating lever 121, an electromagnetic pulse generating means 122 and a power plug 123. The locking block actuating lever 121 is detachably snap-fitted on the locking block 114 in the vertical direction shown. Specifically, the right side of the locking block 114 is provided with a T-shaped mounting recess (not shown in the figure) extending in a thickness direction (the direction perpendicular to the paper) of the locking block such that a head of the locking block actuating lever 121 can be snapped into the T-shaped mounting recess, and the locking block actuating lever 121 can also slide in the T-shaped mounting recess, and does not affect or limit the movement of the locking block 114.

When it is necessary to unlock the door, the control means 160 controls the electromagnetic pulse generating means 122 to transmit an electromagnetic pulse signal to the locking block actuating lever 121, the locking block actuating lever 121 can move upwardly once. When the locking portion 191 of the locking block 114 is locked downwardly in the slider locking recess 181 of the slider 112, the locking block actuating lever 121 can be actuated to drive the locking block 114 to move upwardly as long as the electromagnetic pulse generating means 122 transmits an electromagnetic pulse signal, so as to move the locking portion 191 of the locking block 114 upwardly to unlock the slider 112. In this case, the slider 112 can move in a second direction (i.e., leftward in the figure) opposite to the first direction under the action of the biasing force of the second biasing means, so that the door of the electrical appliance moves in an opening direction, and the user can have the feeling that the door is ejected. When the electromagnetic pulse signal disappears, the locking block 114 abuts downwardly against an unlocked position of an upper side edge of the slider 112, where the locking portion 191 of the locking block 114 is not aligned with the slider locking recess 181 of the slider 112.

FIGS. 2A-2B are respectively partial views A0-1, A0-2 indicated by elliptically circled portions of FIGS. 1A and 1B of the present disclosure, to show the specific structure of the swinging block 117, the mounting relationship of the locking block 114 on the door lock box 104, and the mutual movement relationship of the locking block 114 relative to the slider 112 and the swinging block 117.

As shown in FIGS. 2A-2B, as described above, the swinging block 117 is rotatably mounted inside the door lock box 104 by means of the swinging shaft 115, and the swinging block 117 has a first position of the swinging block shown in FIG. 2A and a second position of the swinging block shown in FIG. 2B. The swinging block 117 has an swinging block protrusion 202 on the radially outer side (the right side in the figures) thereof. The radially outer contour (the right side contour) of the swinging block protrusion 202 is substantially circular arc-shaped, to conform with the circular arc-shaped recess shape of the swinging block slideway 134, such that the swinging block 117 can swing back and forth about the swinging shaft 115 in the swinging block slideway 134. The radially inner contour (the left side contour) of the swinging block protrusion 202 may abut against the swinging block abutment portion 194 of the locking block 114 in a transverse (horizontal) or longitudinal (vertical) direction. Specifically, the radially inner contour of the swinging block protrusion 202 has a transverse abutment wall 204 and a longitudinal abutment wall 206, the transverse abutment wall 204 and the longitudinal abutment wall 206 being connected to each other at an angle. Specifically, the transverse abutment wall 204 extends downwardly, or downwardly and rightward, from the top of the swinging block protrusion 202, and may abut against the swinging block abutment portion 194 in the transverse direction, and the longitudinal abutment wall 206 extends rightward at an angle from a lower portion of the transverse abutment wall 204, and may abut against the swinging block abutment portion 194 in the vertical direction. The swinging block slideway 134 is provided with a longitudinal stop 212 on the upper side thereof to limit the extent to which the swinging block 117 can be swung upwardly. The swinging shaft 115 of the swinging block 117 is provided with an swinging block torsion spring (not shown in the figures) which can provide a biasing force that causes the swinging block 117 to swing toward the first position of the swinging block (to swing downwardly).

Continuing as shown in FIGS. 2A-2B, the door lock device 100 is also internally provided with an unlocking structure for releasing the slider 112 and the locking block 114 from an engaged state (locked state) to disengage the locking portion 191 of the locking block 114 from the slider engagement portion of the slider 112 during movement of the locking block 114 in a second direction. The unlocking structure includes a guiding portion and a guide surface that can abut against each other. In the embodiments of the present disclosure, the guiding portion is a guiding pin 224, which will be described below, and the guide surface is a second guide wall 236, which will be described below. For those skilled in the art, the unlocking structure may include different structures without violating the above-mentioned inventive purpose.

Specifically, the door lock box 104 is internally provided with a limiting pin 222 and a guiding pin 224, and the limiting pin 222 and the guiding pin 224 are formed by protruding from the bottom of the door lock box 104. Accordingly, the locking block 114 is provided with a limiting recess 232 corresponding to the limiting pin 222, and the locking block 114 is further provided with a first guide wall 234 and the second guide wall 236 which face the guiding pin 224. The first guide wall 234 and the second guide wall 236 are smoothly connected to each other at an angle so as to form a continuous guide surface which can abut against the guiding pin 224. The first guide wall 234 and the second guide wall 236 have smooth surfaces so that the guiding pin 224 can slide relative to the surfaces of the first guide wall 234 and the second guide wall 236.

Herein, the limiting recess 232 extends substantially in a length direction of the locking block 114, the width of the limiting recess 232 is substantially equal to the outer diameter of the limiting pin 222 so that the limiting pin 222 can be received and slide in the limiting recess 232. Moreover, the limiting recess 232 can rotate relative to the limiting pin 222 so that the locking block 114 can swing while moving. The first guide wall 234 extends substantially in the length direction of the locking block 114 and is located above the guiding pin 224 such that the guiding pin 224 can limit movement of the locking block 114 by limiting movement of the first guide wall 234. The second guide wall 236 is a wall forming the left contour of the locking portion 191, which has a circular arc-shaped outer contour and is located on a right side of the guiding pin 224 and inclined with respect to the second direction. In an embodiment of the present disclosure, the second guide wall 236 substantially extends along the lower right direction in the form of a circular arc, so that the movement of the locking block 114 is defined by the first guide wall 234 and the second guide wall 236 of the locking block 114 and the guiding pin 224, mainly in that the guiding pin 224 can limit the extent to which the locking block 114 moves downwardly, and when the locking block 114 moves leftward, the guiding pin 224 can abut against the inclined and circular arc-shaped second guide wall 236, in this way the locking block 114 move upwardly inclined, and thus can be disengaged from the slider 112. Specifically, the second guide wall 236 is arranged obliquely to the movement direction of the locking block 114 so that when the second guide wall 236 abuts against the guiding pin 224 and is subjected to abutting force, the inclined smooth surface of the second guide wall 236 slides with respect to the guiding pin 224, so that the locking portion 191 of the locking block 114 can move upwardly inclined under the effect of the guiding pin 224 and the second guide wall 236, thereby moving out of the slider locking recess 181.

As shown in FIG. 2A, in the first embodiment of the door lock device of the present disclosure, in the open door state, due to the biasing force applied by the first biasing means 193 to the locking block 114 toward the lower right, the swinging block abutment portion 194 of the locking block 114 abuts rightward against the transverse abutment wall 204 of the swinging block 117, and the locking portion 191 of the locking block 114 abuts downwardly against the slider abutment surface 242 on the right side of the slider 112. The slider abutment surface 242 is located on the right side of the slider locking recess 181. When the slider 112 slides rightward such that the slider locking recess 181 is aligned with the locking portion 191 of the locking block 114, the locking portion 191 of the locking block 114 can fall into and be engaged with the slider locking recess 181 under the effect of the downward third direction biasing force of the first biasing means 193, and at the same time, the swinging block abutment portion 194 of the locking block 114 also moves downwardly, no longer abuts with the transverse abutment wall 204 of the swinging block 117, and moves to a lower side of the transverse abutment wall 204 so as to continue to move rightward. Under the action of the rightward biasing force of the first biasing means 193, the locking block 114 can drive the slider 112 to continue to move rightward in this state.

As shown in FIG. 2B, in the second embodiment of the door lock device of the present disclosure, when the locking block actuating lever 121 drives the locking block 114 to move upwardly, the locking portion 191 of the locking block 114 disengages from the slider locking recess 181, so that the slider 112 can be unlocked, the swinging block abutment portion 194 of the locking block 114 moves upwardly and abuts against the longitudinal abutment wall 206 of the swinging block 117, causing the swinging block 117 to swing about the swinging shaft 115 toward the second position of the swinging block. When the swinging block 117 is swung to the second position of the swinging block, the swinging block 117 abuts against the longitudinal stop 212 of the swinging block slideway 134 and the swing movement is stop. When the actuating force of the locking block actuating lever 121 on the locking block 114 disappears, the swinging block 117 swings toward the first position of the swinging block (downwardly) under the action of the biasing force of the swinging block torsion spring, to abut against an upper portion of the swinging block abutment portion 194 of the locking block 114; and the locking block 114 has a tendency to move downwardly and rightward under the biasing force of the first biasing means 193, such that the locking portion 191 of the locking block 114 abuts downwardly against the slider abutment surface 242 of the slider 112. In this case, the swinging block abutment portion 194 of the locking block 114 abuts rightward against the radially inner contour below the longitudinal abutment wall 206 of the swinging block protrusion 202 under the biasing force of the first biasing means 193, and the locking block 114 moves transversely (horizontally) to the rightmost position. When the slider 112 slides rightward such that the slider locking recess 181 is aligned with the locking portion 191 of the locking block 114, the locking portion 191 of the locking block 114 can fall down into the slider locking recess 181, while the swinging block 117 swings downwardly as the locking block 114 moves downwardly.

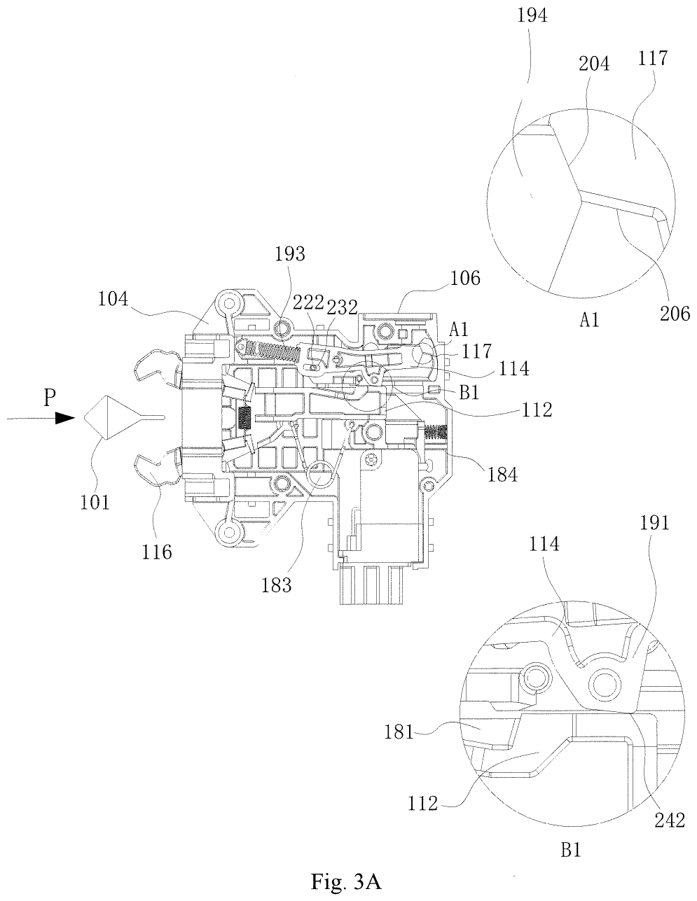

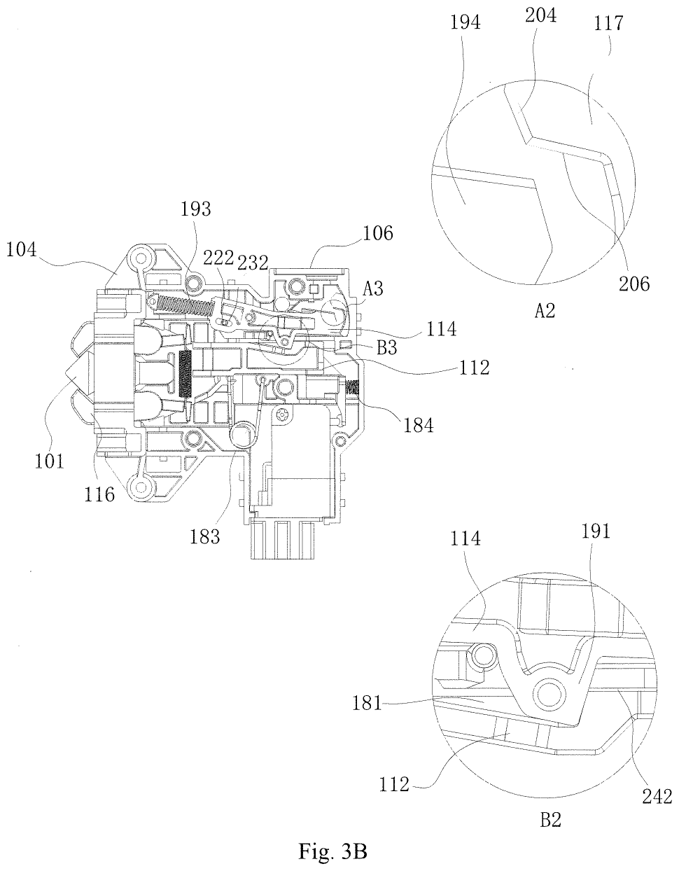

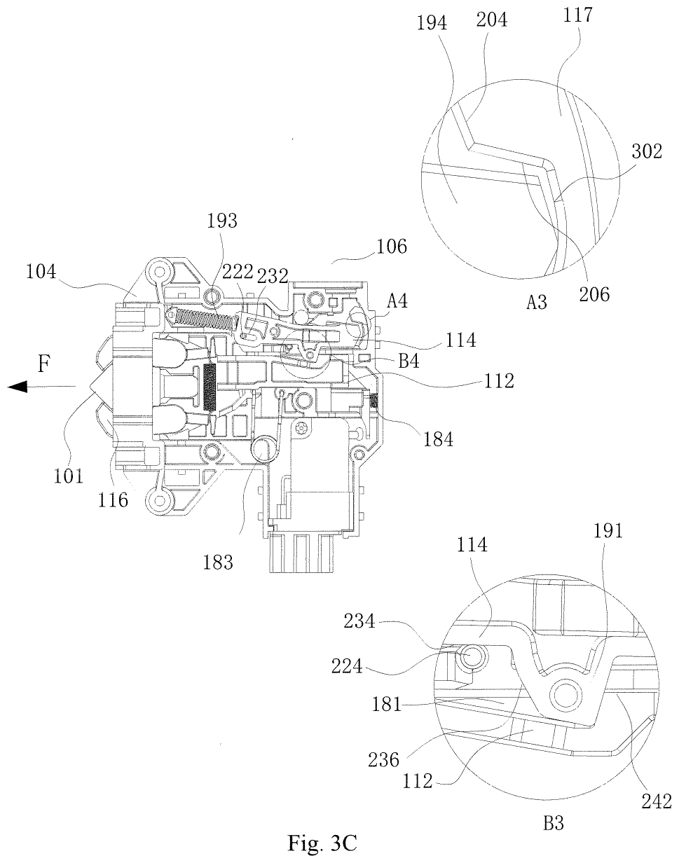

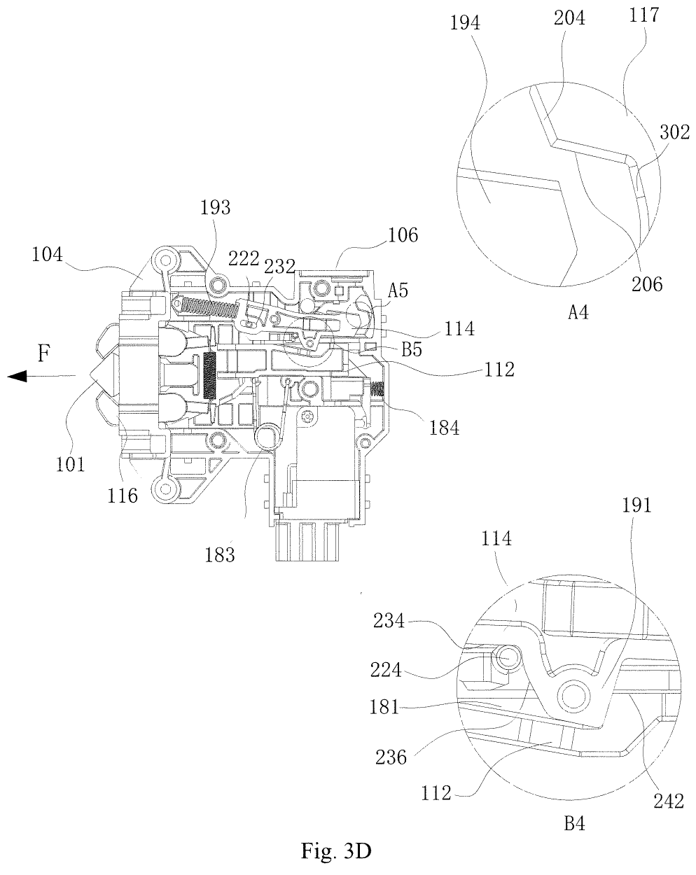

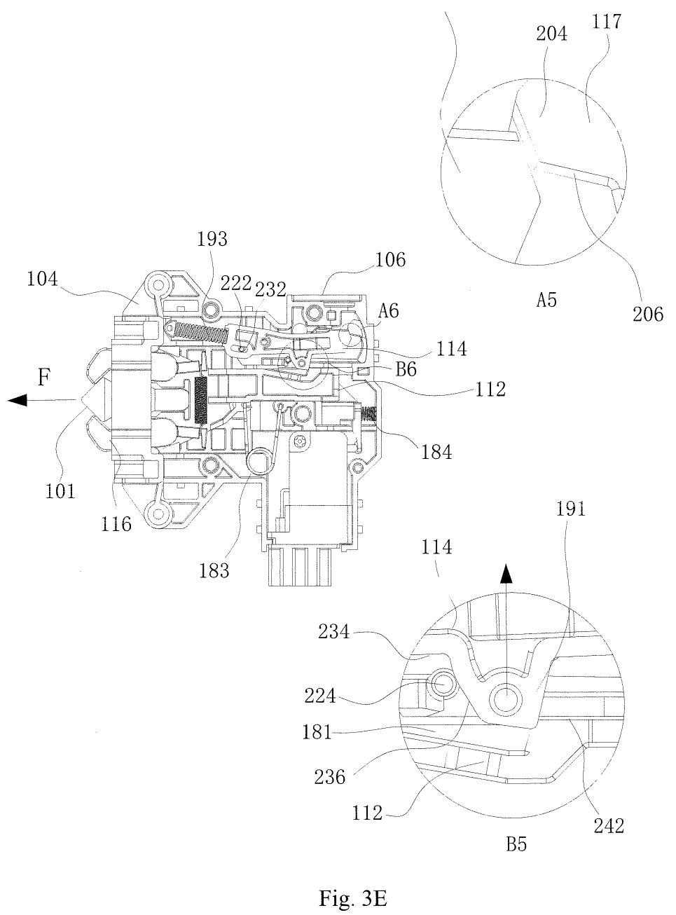

FIGS. 3A-3E show schematic views of the first embodiment of the door lock device of the present disclosure moving from the door open position to the door closed position and from the door closed position to the door open position. FIG. 3A is a schematic view of the first embodiment of the door lock device of the present disclosure in the door open position; FIG. 3B is a schematic view of the first embodiment of the door lock device of the present disclosure in an force-assisted door closing stage; FIG. 3C is a schematic view of the first embodiment of the door lock device of the present disclosure in the door closed position; FIG. 3D is a schematic view of the first embodiment of the door lock device of the present disclosure in a door pulling stage; and FIG. 3E is a schematic view of the first embodiment of the door lock device of the present disclosure in a door pulling and unlocking stage.

As shown in FIG. 3A, in the first embodiment of the door lock device, in the door open position (first position), under the biasing force of the first biasing means 193, the swinging block abutment portion 194 of the locking block 114 abuts rightward against the transverse abutment wall 204 of the swinging block 117 (as detailed in an enlarged view Al at the upper right corner of FIG. 3A for details), and the locking block 114 is therefore blocked from moving rightward by the swinging block 117. In addition, the locking portion 191 of the locking block 114 abuts against the slider abutment surface 242 of the slider 112, as detailed in an enlarged view B1 at the lower right corner of FIG. 3A. In this case, if a pushing force P is applied to the door of the electrical appliance such that a striker 101 on the door pushes the slider 112 rightward and is inserted between the pair of locking arms 116, the inserted striker 101 can be clamped or engaged by the pair of locking arms 116, and the locking arms 116 and the slider 112 connected thereto can move rightward together with the striker 101 relative to the locking block 114.

As shown in FIG. 3B, when the slider 112 slides rightward to a position (third position) where the slider locking recess 181 is aligned with the locking portion 191 of the locking block 114, the locking portion 191 of the locking block 114 can fall into the slider locking recess 181, as detailed in an enlarged view B2 at the lower right corner of FIG. 3B. In addition, the swinging block abutment portion 194 of the locking block 114 is out of abutment with the transverse abutment wall 204 of the swinging block 117 and moves to the lower side of the longitudinal abutment wall 206 (as detailed in an enlarged view A2 at the upper right corner of FIG. 3B) so that the locking block 114 can move rightward under the biasing force of the first biasing means 193, and the door lock device therefore enters the force-assisted door closing stage.

As shown in FIG. 3C, the locking block 114 abuts against the slider locking recess 181 by means of the locking portion 191 under the biasing force of the first biasing means 193 (as detailed in an enlarged view B3 at the lower right corner of FIG. 3C), in this case, the locking portion 191 can apply a first direction biasing force to the slider 192 so that the locking block 114 can drive the slider 112 to move rightward, until the swinging block abutment portion 194 abuts rightward against a longitudinal inner contour 302 below the longitudinal abutment wall 206 of the swinging block 117 (as detailed in an enlarged view A3 at the upper right corner of FIG. 3C), and the door lock device reaches the door closed position (second position).

As can be seen from FIGS. 3A-3C, during closing of the door of the electrical appliance, by continuously applying a pushing force P to the door between the states of the door lock device in FIGS. 3A-3B, the door lock device moves to the state shown in FIG. 3B. During the above process, the rightward movement of the slider 112 causes the opening of the locking arm 116 to decrease, thereby clamping or engaging the striker 101 between an upper locking arm 141 and a lower locking arm 142 of the locking arms 116. When the door lock device moves to the state shown in FIG. 3B, the door lock device can drive the slider 112 and the locking block 114 to move rightward under the combined biasing force applied by the first biasing means 193 and the second biasing means (slider torsion springs 183 or slider compression spring 184) to the locking block 114 and the slider 112, so as to drive the striker 101 to move rightward together, eventually closing the door. The above-mentioned movement mechanism of the door lock device enables the door to be moved from the state shown in FIG. 3B to the state shown in FIG. 3C by means of the first direction biasing force, not only to save the force of the user to push the door continuously, but also to give the user the feeling that the door is sucked by the door lock device when the door is pushed to a door closing critical position. This suction feeling can enhance the user's experience of using the electrical appliance.

As shown in FIG. 3C, if the door of the electrical appliance is to be opened from the door closed position, a pulling force F is continuously applied to the door in the door opening direction (leftward direction in this figure). Under the action of the pulling force F, the striker 101 drives the upper locking arm 141 and the lower locking arm 142 of the locking arms 116 to move leftward, so as to drive the slider 112 to move leftward. The slider 112 abuts against the locking block 114, drives the locking block 114 to move leftward together, in which case the door lock device enters the door pulling stage shown in FIG. 3D.

As shown in FIG. 3D, under the continuous action of the pulling force F, the locking block 114 continues to move leftward, the abutment portion 194 of the locking block 114 is out of abutment with the longitudinal abutment wall 206 and the longitudinal inner contour 302 of the swinging block 117 (as detailed in an enlarged view A4 at the upper right corner of FIG. 3D), and the second guide wall 236 of the locking block 114 moves leftward to abut against the guiding pin 224, as detailed in an enlarged view B4 at the lower right corner of FIG. 3D.

As shown in FIG. 3E, if the pulling force F continues to be applied, the door lock device enters the door pulling and unlocking stage. Under the mutual abutment of the guiding pin 224 and the circular arc-shaped surface of the second guide wall 236, the second guide wall 236 will move upwardly and leftward relative to the guiding pin 224, so that the locking portion 191 of the locking block 114 can swing upwardly relative to the guiding pin 224 (as detailed in an enlarged view B5 at the lower right corner of FIG. 3E). During the upward swing of the locking block 114 and its locking portion 191, the limiting recess 232 also moves leftward by a certain distance relative to the limiting pin 222, the limiting recess 232 rotates by an angle relative to the limiting pin 222, and the abutment portion 194 of the locking block 114 also moves leftward and swings upwardly to the left side of the transverse abutment wall 204 of the swinging block 117 (as detailed in an enlarged view A5 at the upper right corner of FIG. 3E). If the locking block 114 continues to apply the pulling force F in the state shown in FIG. 3E, the locking portion 191 of the locking block 114 can swing upwardly and move out of the slider locking recess 181 and abut against the slider abutment surface 242 on the right side of the slider locking recess 181 under the action of the biasing force of the first biasing means 193, and the abutment portion 194 of the locking block 114 abuts against the left side of the transverse abutment wall 204 of the swinging block 117, to overcome the biasing force of the first biasing means 193. After the locking portion 191 of the locking block 114 swings upwardly and move out of the slider locking recess 181, the locking block 114 unlocks the slider 112 such that the slider 112 can continue to move leftward under the action of the pulling force F, thereby gradually increasing the opening of the locking arms 116. When the slider 112 moves leftward to approach the door open position shown in FIG. 3A, the upper locking arm 141 and the lower locking arm 142 of the locking arms 116 can release the striker 101 so that the door can be opened, and the door lock device completes the movement from the door closed position to the door open position.

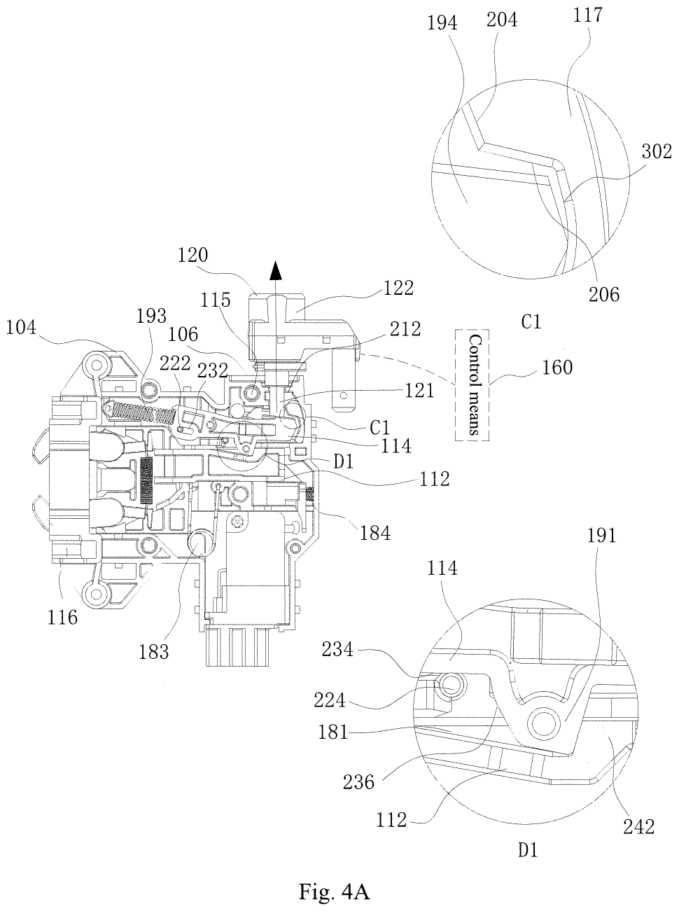

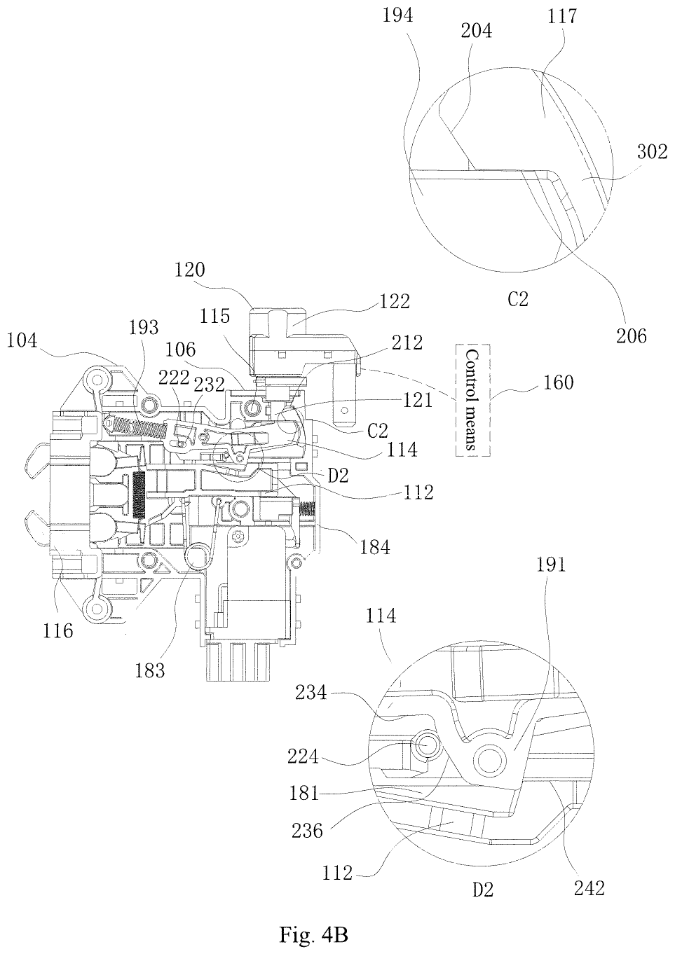

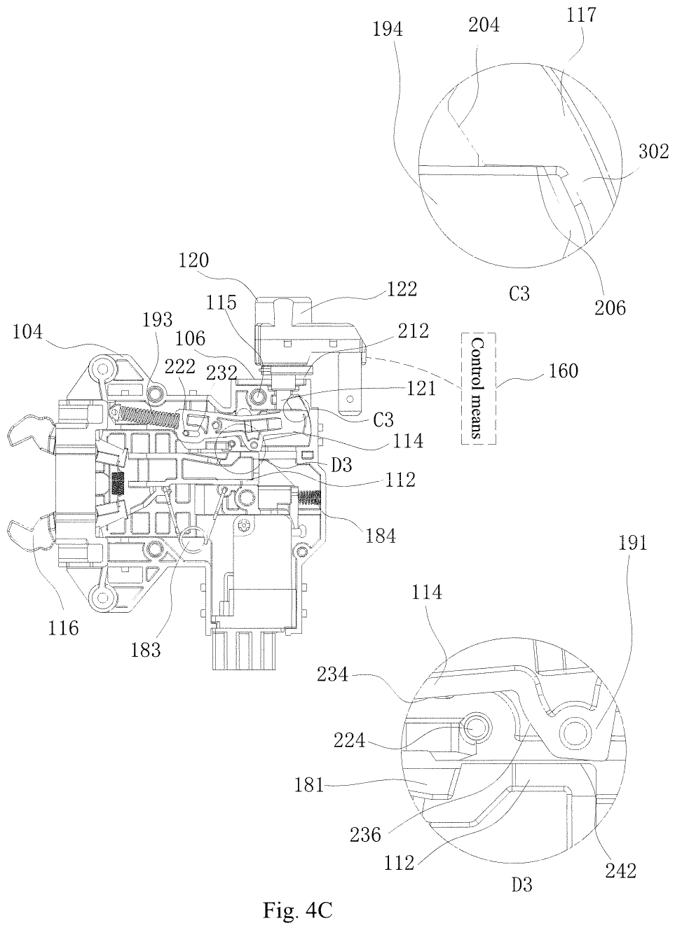

FIGS. 4A-4C show schematic views of the second embodiment of the door lock device of the present disclosure moving from the door closed position to the door open position. FIG. 4A is a schematic view of the second embodiment of the door lock device of the present disclosure in the door closed position; FIG. 4B is a schematic view of the second embodiment of the door lock device of the present disclosure in an unlocking critical position; and FIG. 4C is a schematic view of the second embodiment of the door lock device of the present disclosure in an unlocked position.

As shown in FIG. 4A, the second embodiment of the door lock device of the present disclosure differs from the first embodiment in that the door lock device is further provided with an electromagnetic unlocking means 120 and a control means 160 communicatively connected to the electromagnetic unlocking means 120. In the door closed position, the relative position between the swinging block abutment portion 194 and the swinging block 117 and the relative position between the locking block 114 and the slider 112 in the second embodiment of the door lock device are the same as those in the first embodiment of the door lock device shown in FIG. 3C, as detailed in an enlarged view C1 at the upper right corner of FIG. 4A and an enlarged view D1 at the lower right corner of FIG. 4A, which will not be described here again.

As shown in FIGS. 4A-4B, in the door closed position, when it is necessary to unlock the door, the control means 160 controls the electromagnetic pulse generating means 122 to transmit an electromagnetic pulse signal to the locking block actuating lever 121, the locking block actuating lever 121 may move upwardly once to drive the locking block 114 to swing upwardly so that the swinging block abutment portion 194 of the locking block 114 swings upwardly to a position where it abuts against the longitudinal abutment wall 206 of the swinging block 117, and to drive the longitudinal abutment wall 206 of the swinging block 117 to swing upwardly together, until the swinging block 117 swings to a position where it abuts against the longitudinal stop 212 of the swinging block slideway 134, as detailed in an enlarged view C2 at the upper right corner of FIG. 4B. The locking portion 191 of the locking block 114 also swings upwardly together with the locking block 114 to unlock the slider 112, as detailed in an enlarged view D2 at the lower right corner of FIG. 4B. In this case, the door lock device is in the unlocking critical position, the slider 112, due to the loss of locking of the locking block 114, can be ejected leftward by the biasing force of the second biasing means 183, thereby opening the door of the electrical appliance.

As shown in FIG. 4C, when the electromagnetic pulse signal disappears, the locking block 114 has a tendency to move downwardly under the action of the biasing force of the first biasing means 193. In this case, since the slider 112 slides leftward to a position (unlocked position) where the slider locking recess 181 is not aligned with the locking portion 191 of the locking block 114, the locking portion 191 of the locking block 114 can abut downwardly against the slider abutment surface 242 on the right side of the slider locking recess 181, as detailed in an enlarged view D3 at the lower right corner of FIG. 4C. The swinging block 117 has a tendency to swing downwardly under the biasing force of the swinging block torsion spring (not shown in the figures), so that the swinging block 117 no longer abuts against the longitudinal stop 212 of the swinging block slideway 134, and the longitudinal abutment wall 206 of the swinging block 117 abuts downwardly against the swinging block abutment portion 194 of the locking block 114. Since the swinging block abutment portion 194 of the locking block 114 only swings upwardly and does not move leftward in the door opening stage, the swinging block abutment portion 194 still abuts rightward against the longitudinal inner contour 302 below the longitudinal abutment wall 206 of the swinging block 117 under the action of the biasing force of the first biasing means 193, as detailed in an enlarged view C3 at the upper right corner of FIG. 4C.

If the door is reclosed in the state shown in FIG. 4C, it is only necessary to apply a continuous pushing force P to the door again such that the slider 112 slides rightward to a position where the slider locking recess 181 is aligned with the locking portion 191 of the locking block 114, and the locking portion 191 of the locking block 114 can thus swing downwardly into the slider locking recess 181 under the action of the biasing force of the first biasing means 193, to lock the slider 112, which in turn closes and locks the door.

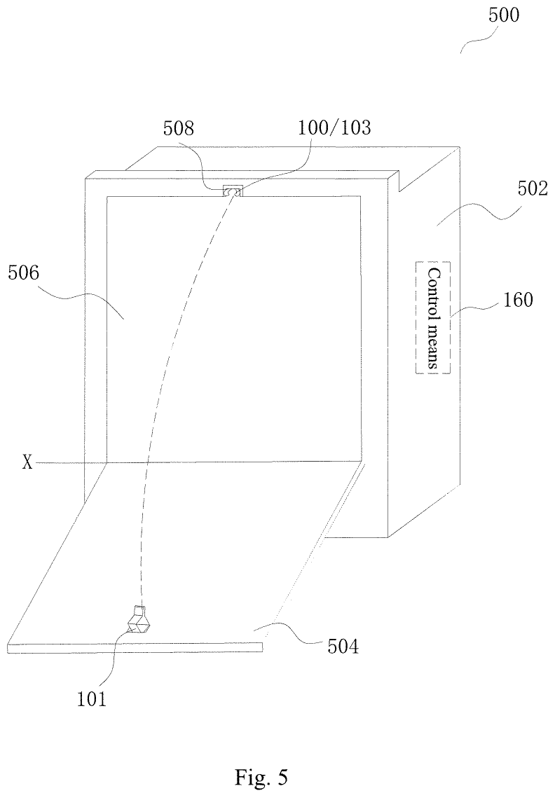

FIG. 5 is a schematic view of an electrical appliance 500 having the door lock device of the present disclosure.

As shown in FIG. 5, the electrical appliance 500 in the present disclosure may be a dishwasher having a dishwasher main body 502, a dishwasher door 504, a dishwasher cavity 506, and the door lock device 100/103 of the first or second embodiment of the present disclosure. A striker 101 is mounted inside the dishwasher door 504, and the door lock device 100/103 is arranged at a position on the dishwasher main body 502 corresponding to the striker 101. The dishwasher main body 502 is provided with a striker hole 508 on the outer side thereof corresponding to the door lock device 100/103. By pushing the dishwasher door 504 to close, the striker 101 can pass through the striker hole 508 and cooperates with the door lock device 100/103, to close the dishwasher door 504 and lock it in a closed position. The control means 160 is arranged inside the dishwasher main body 502 and can operate the dishwasher door 504 in the closed state to be automatically ejected by electromagnetic action.

The dishwasher shown in FIG. 5 is merely exemplary, and the door lock device of the present disclosure can also be mounted on various types of electrical appliances having a cavity and a door for closing the cavity, such as a washing machine, a dryer, a microwave oven, and can also be mounted on other non-electrical appliances.

The door lock device of the present disclosure has at least the following beneficial technical effects.

First, the door lock device of the present disclosure enables the door to be closed and locked automatically in a final door closing stage, and can provide the user with a “suction” feeling, thereby improving the user's experience.

Second, the door lock device of the present disclosure has a modular design, including a travel switch module and an electromagnetic ejecting module. The user can choose whether to mount the electromagnetic ejecting module as needed, so as to freely choose whether the electrical appliances have the automatic ejecting function or not. The travel switch module and the electromagnetic ejecting module can be respectively manufactured from different materials, to accommodate the different functional requirements of the different modules.

Third, the electromagnetic ejecting module of the door lock device of the present disclosure can unlock the door through the electromagnetic pulse and quickly eject the door to open, so that the door opening action is quick without delay.

Fourth, the travel switch module and the electromagnetic ejecting module of the door lock device of the present disclosure have a flat structure as a whole, and all the assemblies of the travel switch module are arranged in the flat door lock box for easy mounting on a dishwasher, and will not interfere with other components of the dishwasher.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in the present disclosure are illustrative rather than restrictive. Therefore, the disclosed description in the present disclosure may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

1. A door lock device, comprising:
a slider comprising a slider engagement portion, the slider being configured to reciprocate in a first direction and a second direction opposite to the first direction between a first position and a second position;
a locking block comprising a locking portion, the locking block being configured to be movable relative to the slider to removably engage the locking portion with the slider engagement portion; and
a first biasing means configured to apply, to the slider during movement of the slider from the first position to the second position in the first direction in a state in which the locking portion is engaged with the slider engagement portion, a first direction biasing force which actuates the slider to move in the first direction.

2. The door lock device of claim 1, wherein the first biasing means is configured to apply the first direction biasing force to the locking block such that the locking portion applies the first direction biasing force to the slider after the locking portion is engaged with the slider engagement portion.

3. The door lock device of claim 2, wherein a travel of the slider moving in the first direction comprises a third position between the first position and the second position, when the slider moves in the first direction to the third position, the locking portion is engageable with the slider engagement portion such that the first biasing means can apply the first direction biasing force to the slider.

4. The door lock device of claim 3, wherein the first biasing means is configured to apply a third direction biasing force to the locking block, the third direction biasing force drives the locking block to move relative to the slider in the third direction to engage the locking portion with the slider engagement portion when the slider moves to the third position.

5. The door lock device of claim 1, wherein
the first biasing means is an elastic component.

6. The door lock device of claim 4, further comprising:
a second biasing means configured to apply, to the slider during movement of the slider from the second position to the first position in the second direction, a second direction biasing force which causes the slider to move in the second direction.

7. The door lock device of claim 6, wherein
the second biasing means comprises one or more elastic components.

8. The door lock device of claim 6, wherein
the first biasing means is configured to enable the first direction biasing force applied by the first biasing means to cause the locking block to overcome the second direction biasing force of the second biasing means, to actuate the slider to move in the same direction during the movement of the locking block from the first position to the second position in the first direction.

9. The door lock device of claim 1, wherein
the slider engagement portion is a slider locking recess, the locking portion being capable of entering the slider locking recess during movement of the locking block to engage the locking block with the slider.

10. The door lock device of claim 8, further comprising:
an unlocking structure configured to disengage the locking portion of the locking block from the slider engagement portion of the slider during movement of the locking block in a second direction.

11. The door lock device of claim 10, wherein the unlocking structure comprises:
a guiding portion; and
a guide surface which is a side surface of the locking block facing the guiding portion, the guide surface being arranged obliquely with respect to the second direction, the guide surface being capable of interacting with the guiding portion during movement of the locking block toward the second movement direction, to enable the locking portion to be disengaged from the slider engagement portion.

12. The door lock device of claim 11, further includes:
a blocking portion configured such that the blocking portion abuts against the locking block to prevent the locking block from moving toward the second position before the slider moves to the third position in the first direction; and when the slider moves to the third position in the first direction, the locking portion aligns with the slider engagement portion along the third direction, to enable the locking block to disengage from the blocking portion under action of the third direction biasing force such that the locking portion engages with the slider engagement portion.

13. The door lock device of claim 12, wherein:
after the slider moves in the second direction and the locking portion disengages from the slider engagement portion, the blocking portion abuts against the locking block to prevent the locking block from moving towards the second position.

14. The door lock device of claim 1, further comprising:
an electromagnetic unlocking means detachably connected to the locking block and capable of driving the locking block such that the locking portion can be disengaged from the slider engagement portion.

15. The door lock device of claim 14, further comprising:
a control means communicatively connected to the electromagnetic unlocking means to send a control signal to the electromagnetic unlocking means so as to drive the locking block to move.

16. The door lock device of claim 14, further comprising:
a door lock box, wherein the slider, the locking block and the first biasing means are arranged in the door lock box, and the electromagnetic unlocking means is detachably connected to the door lock box.

17. The door lock device of claim 3, further comprising:
a pair of locking arms arranged at an end of the slider away from the slider engagement portion, the pair of locking arms being configured to be switched between an open state and a closed state to receive or release a component for applying external pull force and external push force to the slider, wherein the slider is configured to move from the first position to the third position under action of the external push force and move from the second position to the first position under action of the external pull force.

18. A door lock device, comprising:
the door lock device of claim 1; and
an electromagnetic unlocking means detachably connected to the locking block and capable of driving the locking portion of the locking block such that the locking portion can be disengaged from the slider engagement portion; and
a control means communicatively connected to the electromagnetic unlocking means to send a control signal to the electromagnetic unlocking means so as to drive the locking block to move.

19. An electrical appliance, comprising a door lock device of claim 1, the door lock device being configured to open or close a door of the electrical appliance.
